(19) United States
(12) Patent Application Publication
(10) Pub. No.: US 2016/0377751 A1
(43) Pub. Date: Dec. 29, 2016

(54) SYSTEMS AND METHODS FOR IDENTIFYING S-WAVE REFRACTIONS UTILIZING SUPERVIRTUAL REFRACTION INTERFEROMETRY

(71) Applicant: CGG SERVICES SA, Massy (FR)

(72) Inventors: Kristof DE MEERSMAN, Massy (FR); Yoones VAEZI, Massy (FR)

(21) Appl. No.: 15/039,911

(22) PCT Filed: Nov. 25, 2014
(86) PCT No.: PCT/EP2014/075480

§ 371 Date: Jun. 4, 2015

Related U.S. Application Data
(60) Provisional application No. 61/909,708, filed on Nov. 27, 2013.

(51) Int. Cl. G01V 1/28; G01V 1/30; G01V 1/36

(52) U.S. Cl. CPC G01V 1/284; G01V 1/282; G01V 1/364; G01V 1/301; G01V 2210/614; G01V 2210/6161

(57) ABSTRACT

A system and method for identifying S-wave refractions using supervirtual refraction interferometry is disclosed. The method includes receiving a seismic data set from data generated by a plurality of receivers, and calculating crosscorrelations of pairs of common receiver gathers from the seismic data set for each of the receivers. The method includes summing the crosscorrelations associated with each of a plurality of virtual ray paths, calculating a plurality of virtual refraction gathers of the summed crosscorrelations and convolving each of the virtual refraction gathers with the seismic data set. The virtual ray paths are based on each of the receivers functioning as a virtual source. The method includes summing the plurality of convolutions associated with each of the virtual ray paths and calculating a supervirtual refraction gather of the summed convolutions. The method further includes outputting the S-wave refraction from the supervirtual refraction gather.

### CROSS-REFERENCE TO RELATED APPLICATION

This application claims the benefit under 35 U.S.C. §119(e) of U.S. Provisional Application Ser. No. 61/909,708 filed on Nov. 27, 2013, which is incorporated by reference in its entirety for all purposes.

### TECHNICAL FIELD

The present invention relates generally to seismic exploration and, more particularly, to identifying and improving the quality of S-wave refractions using supervirtual refraction interferometry.

### BACKGROUND

In the oil and gas industry, geophysical survey techniques are commonly used to aid in the search for and evaluation of subterranean hydrocarbon or other mineral deposits. Generally, a seismic energy source, or “source,” generates a seismic signal that propagates into the earth and is partially reflected, refracted, diffracted or otherwise affected by one or more geologic structures within the earth, for example, by interfaces between underground formations having varying acoustic impedances. The reflections are recorded by seismic detectors, or “receivers,” located at or near the surface of the earth, in a body of water, or at known depths in boreholes, and the resulting seismic data can be processed to yield information relating to the location and physical properties of the subsurface formations. Seismic data acquisition and processing generates a profile, or image, of the geophysical structure under the earth's surface. While this profile does not provide an accurate location for oil and gas reservoirs, it suggests, to those trained in the field, the presence or absence of them.

Various sources of seismic energy have been used to impart the seismic waves into the earth. Such sources have included two general types: 1) impulsive energy sources and 2) seismic vibrator sources. The first type of geophysical prospecting utilizes an impulsive energy source, such as dynamite or a marine air gun, to generate the seismic signal. With an impulsive energy source, a large amount of energy is injected into the earth in a very short period of time. In the second type of geophysical prospecting, a vibrator is used to propagate energy signals over an extended period of time, as opposed to the near instantaneous energy provided by impulsive sources. Thus, selection of a type of source dictates the amount, time characteristics, and frequencies of the data collected.

The seismic signal is emitted from a source in the form of waves that are reflected off interfaces between geological layers. When a seismic wave encounters an interface between different media in the earth's subsurface a portion of the wave is reflected back to the earth's surface while the remainder of the wave is refracted through the interface. The reflected waves are received by an array of geophones, hydrophones, or receivers, located at the earth's surface, in a body of water, downhole in a wellbore, or on a sea floor, which convert the displacement of the ground or water resulting from the propagation of the waves into an electrical signal recorded by means of recording equipment. The receivers record the time at which each reflected wave is received. The travel time from source to receiver, along with the velocity of the source wave, can be used to reconstruct the path of the waves to create an image of the subsurface.

A large amount of data may be recorded by the receivers and the recorded signals may be subjected to signal processing before the data is ready for interpretation. The recorded seismic data includes signals from seismic waves that can be obscured due to high noise levels in the data. Thus, the recorded seismic data may be processed to yield information relating to the location of the subsurface reflectors and the physical properties of the subsurface formations. That information is then used to generate an image of the subsurface.

Typical seismic exploration may involve the creation of multiple types of source waves: surface waves and body waves. Surface waves are the waves that travel along the earth's surface when the seismic energy signal is emitted. Body waves travel into the interior of the earth and generate the reflected waves, such as P-waves (primary waves) and S-waves (secondary waves). A P-wave may be referred to as a primary wave, pressure wave, longitudinal wave, or compressional wave. P-waves are referred to as a primary wave because a reflected P-wave is typically the first wave to arrive at a particular receiver. P-waves are the most commonly used form of seismic wave. P-waves cause particles to oscillate parallel to the direction in which the wave propagates. S-waves may be referred to as shear waves or secondary waves. An S-wave, generated by most land seismic sources and sometimes by converted P-waves, is a wave in which particles oscillate perpendicular to the direction in which the wave propagates. S-waves are polarized in the horizontal plane (classified as SH waves) and in the vertical plane (classified as SV waves). In some cases, S-waves can be converted to P-waves. The conversion of a P-wave into S-waves generates converted-wave (or PS-wave) data. Unconverted P-waves generate PP-wave data. Further, refracted S-waves (or “S-wave refractions”) are S-waves that travel along an subterranean interface for a distance and then emit energy back up to receivers.

Multicomponent technology has been introduced to the seismic exploration industry and developed during the last decades. Multicomponent refers to measurements made with vertical and horizontal component geophones or a hydrophone that allows recording of P-waves. Multicomponent receivers capture a more complete seismic wavefield than receivers that are designed to be responsive to only P-waves or S-waves. Thus, utilization of multicomponent geophones, for example, 3C geophones, allow recording of the vertical and horizontal components of S-waves. For example, multicomponent receivers allow the creation of converted-wave (or PS-wave) images that are used in applications such as lithology analysis, fracture detection, fluid discrimination, and imaging below a gas cloud.

However, seismic processing of multicomponent data differs from that of conventional recorded data in many aspects. For example, in analysis of seismic data, identification of S-wave refractions received at a receiver is difficult when utilizing PS-wave data. PS-waves typically arrive at the receivers first and mask or obscure the S-wave refraction first arrivals (or “first breaks”) in the data. Identification of S-wave refractions may improve generation of subsurface images.

Seismic processing of multicomponent data may include steps such as anisotropic rotations, S-wave receiver statics, asymmetric binning, non-hyperbolic velocity analysis, normal moveout (NMO) correction, PS-wave to PP-wave time transformation, prestack migration with two velocities and wavefields, stacking velocity calculation, reflectivity inversion for S-wave velocities, or other suitable processing steps. Among these, S-wave receiver statics and associated near-surface S-wave velocity models may be more difficult to determine.

The near-surface includes elevation changes, weathered material, or other characteristics that interfere with rays received by receivers, and thus, may introduce noise into the recorded seismic data. As such, processing methodologies may be unable to identify and enhance a selected wave to a point where it is useable to create an image of subsurface formations.

In seismic processing, because of the noise introduced by the near-surface, there is difficulty in identifying and interpreting near-surface S-wave velocities resulting in low quality subsurface images and long turnaround times for converted-wave (PS-wave) data. The depth of the near-surface may be based in part on how far below the surface a particular target is located. For example, for a relatively shallow target (approximately five-hundred meters), the weathering layer may be less than approximately fifty meters, but for relatively deep targets (approximately two kilometers), the weathering layer may be approximately 100-150 meters. Thus, the depth of the near-surface may be variable from one seismic dataset to another. As such, near-surface S-wave velocity models from the received seismic data are difficult to generate. Statics corrections (or “statics”) may be applied to the received seismic data to compensate for the effects of variations in elevation, weathering thickness, weathering velocity, or reference to a datum. Statics are corrections used in time processing and time imaging. Applying a statics correction includes determining a particular wave arrival time that would have been observed if all measurements were made on a flat or smooth surface with no weathering or low-velocity material present. For example, a statics correction may be applied to data received at a receiver at one elevation as if that receiver were located at a higher or lower elevation. Further, a near-surface S-wave velocity model may be utilized to assist in depth processing of PS-wave data.

Accordingly, less efficient methods to generate accurate near-surface S-wave velocity models contribute to low quality images and long processing times in many PS-wave projects. Variation due to statics results in a significant loss of high frequencies in subsequent processing and complicates event correlation in combined PP-wave and PS-wave interpretation. Further, S-wave statics may not easily be approximated by scaling known P-wave statics because (a) compared with P-waves, S-waves have lower near-surface velocities, leading to statics for S-waves as large as approximately ten times that of P-waves; and (b) S-waves are less affected by the water table than P-waves and thus, have statics solutions independent of P-waves. In short, P-wave data may not be used to predict accurately S-wave statics. Thus, it would be useful to provide systems and methods that improve the identification and quality of S-wave refractions from multicomponent measurements to improve the quality of and turnaround time for subsurface images.

### SUMMARY

In accordance with one or more embodiments of the present disclosure, a method for analyzing seismic data includes receiving a seismic data set from data generated by a plurality of receivers. The method includes calculating crosscorrelations of pairs of common receiver gathers from the seismic data set for each of the plurality of receivers, and summing the crosscorrelations associated with each of a plurality of virtual ray paths. The plurality of virtual ray paths are based on each of the plurality of receivers functioning as a virtual source. The method also includes calculating a plurality of virtual refraction gathers of the summed crosscorrelations, and convolving each of the plurality of virtual refraction gathers with the seismic data set. The method includes summing the plurality of convolutions associated with each of the plurality of virtual ray paths, and calculating a supervirtual refraction gather of the plurality of summed convolutions. The method further includes outputting the S-wave refraction from the supervirtual refraction gather.

In accordance with another embodiment of the present disclosure, a seismic processing system includes a plurality of receivers configured to receive seismic data. The system includes a computing system configured to receive a seismic data set from data generated by the plurality of receivers. The computing system is further configured to calculate crosscorrelations of pairs of common receiver gathers from the seismic data set for each of the plurality of receivers, and calculate crosscorrelations of pairs of common receiver gathers from the seismic data set for each of the plurality of receivers. The computing system is also configured to sum the crosscorrelations associated with each of a plurality of virtual ray paths. The plurality of virtual ray paths are based on each of the plurality of receivers functioning as a virtual source. The computing system is configured to calculate a plurality of virtual refraction gathers of the summed crosscorrelations, convolve each of the plurality of virtual refraction gathers with the seismic data set, and sum the plurality of convolutions associated with each of the plurality of virtual ray paths. The computing system is additionally configured to calculate a supervirtual refraction gather of the plurality of summed convolutions, and output an S-wave refraction from the supervirtual refraction gather.

In accordance with another embodiment of the present disclosure, non-transitory computer-readable storage medium includes computer-executable instructions carried on the computer-readable medium. The instructions, when executed, cause a processor to receive a seismic data set from data generated by a plurality of receivers. The processor is further caused to calculate crosscorrelations of pairs of common receiver gathers from the seismic data set for each of the plurality of receivers, and sum the crosscorrelations associated with each of a plurality of virtual ray paths. The plurality of virtual ray paths are based on each of the plurality of receivers functioning as a virtual source. The processor is also caused to calculate a plurality of virtual refraction gathers of the summed crosscorrelations, convolve each of the plurality of virtual refraction gathers with the seismic data set, and sum the plurality of convolutions associated with each of the plurality of virtual ray paths. The processor is additionally caused to calculate a supervirtual refraction gather of the plurality of summed convolutions, and output an S-wave refraction from the supervirtual refraction gather.

### BRIEF DESCRIPTION OF THE DRAWINGS

For a more complete understanding of the present invention and its features and advantages, reference is now made to the following description, taken in conjunction with the accompanying drawings, in which like reference numbers indicate like features and wherein:

FIGS. 1A and 1B illustrate a graphical example of supervirtual refraction interferometry (SVI) in accordance with some embodiments of the present disclosure;

FIG. 2 illustrates a vertical cross-section view of propagation of an example seismic wavefield in accordance with some embodiments of the present disclosure;

FIG. 3 illustrates example radial component seismic data recorded by receivers in accordance with some embodiments of the present disclosure;

FIG. 4 illustrates an example of a window output of the seismic data shown in FIG. 3 in accordance with some embodiments of the present disclosure;

FIG. 5 illustrates an example crosscorrelation of a common receiver gather (CRG) with another nearby CRG in accordance with some embodiments of the present disclosure;

FIG. 6 illustrates an example virtual refraction gather for a particular receiver in accordance with some embodiments of the present disclosure;

FIG. 7 illustrates an example supervirtual refraction gather in accordance with some embodiments of the present disclosure;

FIGS. 8A and 8B illustrate the effects of statics corrections computed from first break tomography in accordance with some embodiments of the present disclosure;

FIG. 9 illustrates a flow chart of an example method of identifying S-wave refractions utilizing SVI in accordance with some embodiments of the present disclosure; and

FIG. 10 illustrates a schematic diagram of an example seismic exploration system in accordance with some embodiments of the present disclosure.

### DETAILED DESCRIPTION

In seismic data processing, difficulty in interpreting near-surface S-wave velocities can result in low quality subsurface images when using PS-wave datasets. Identifying S-wave refractions observed on PS-wave datasets may improve the interpretation of near-surface S-wave velocities and thus, the quality of subsurface images. S-wave refractions appear on the radial component of a PS-wave dataset and may be mistaken or misidentified as generic surface wave noise. The radial component is obtained by rotating the two horizontal receiver components such that one component points in the direction from source to receiver and the second (transverse) component is perpendicular to the radial. As opposed to P-wave refractions, S-wave refractions are not the first arrival and are typically of lower energy. S-wave refractions may be affected by interference with PS-wave reflections, and thus, may be difficult to pick (or identify). Thus, it may be difficult to build a near-surface velocity model because the S-wave refractions may not be the first arrival, may be obscured by interfering energy, may have a lower amplitude relative to other waves, or may have a low signal-to-noise ratio (SNR) due to source signal attenuation, cylindrical divergence, or ambient noise. Accordingly, utilization of supervirtual refraction interferometry (SVI) may increase SNR and improve picking of S-wave refractions recorded by multicomponent (3C) receivers. Using SVI may increase the SNR and improve the ability to pick S-wave refraction first arrivals at further offsets. The picked S-wave refractions may be processed, for example, by tuning-ray tomography or other suitable processes, to generate an accurate near-surface velocity model. The near-surface S-wave velocity model may then be utilized to calculate S-wave receiver statics with less processing, time, and cost. Further, the near-surface velocity model may be used for depth imaging of PS or SS reflections. or other suitable geotechnical application.

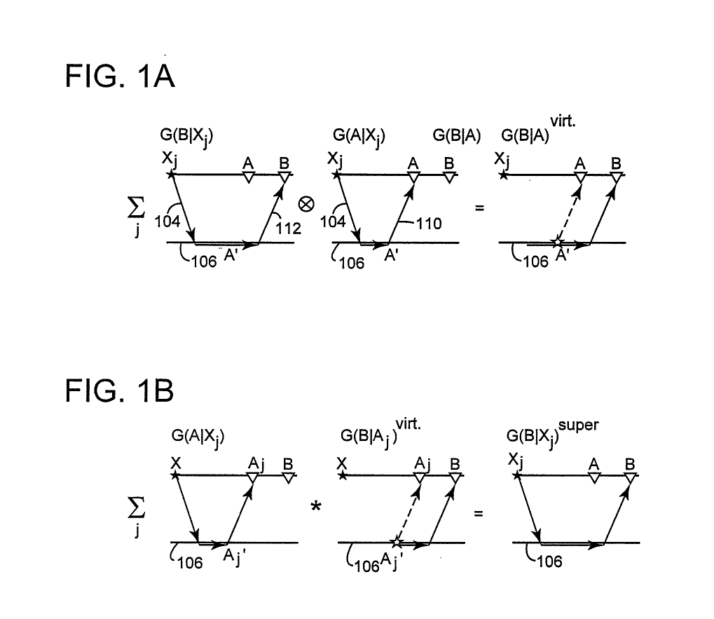

FIGS. 1A and 1B illustrate a graphical example of SVI in accordance with some embodiments of the present disclosure. SVI is a process for creating a supervirtual trace between any source xⱼ and receiver B, as described in Pawan Bharadwaj et al., Theory of Supervirtual Refraction Interferometry, Geophys. J. Int. 188, 263-273 (2012), incorporated in material part by reference herein. SVI includes two processing steps: (a) crosscorrelating recorded responses at receivers A and B for each source xⱼ and summing over these sources to create virtual refractions redatumed onto the virtual source position A′ as depicted in FIG. 1A; and (b) convolving the obtained virtual refraction and the original record at each intermediate receiver Aⱼ and then summing over them to create supervirtual refractions between each source xⱼ and receiver B as depicted in FIG. 1B.

In FIG. 1A, source xⱼ emits a head wave that travels along trajectory 104 until it reaches interface 106. A head wave may be a P-wave that travels along an interface, such as interface 106. Interface 106 is approximately smooth. The wave travels along interface 106 and travels on trajectories 110 and 112 to be recorded by receivers A and B. The first step in SVI is crosscorrelation of recorded responses at receivers A and B for each source xⱼ. Accordingly, the recorded head wave excited by source xⱼ and recorded by receiver B is mathematically approximated by:

G(B|xⱼ)=e^{iωτ}^{_{xB}}=e^{iω(τ}^{_{xA′}}^{+τ}^{_{A′B}}⁾

The recorded head wave excited by source xⱼ and recorded by receiver A is mathematically approximated by:

G(A|xⱼ)=e^{iωτ}^{_{xA}}=e^{iω(τ}^{_{xA′}}^{+τ}^{_{A′A}}⁾

where:

G=Green's function;

ω=angular frequency;

τ_{xB}=refraction travel time from source x to receiver B along the ray xA′B; and

τ_{xA}=refraction travel time from source x to receiver A along the ray xA′A.

Recorded traces at receivers A and B for each source xⱼ post-critically offset (beyond a critical distance that is site dependent) from receivers A and B are crosscorrelated. Each of the crosscorrelated traces is then summed for each source xⱼ. Note that crosscorrelation of two time series is equivalent to the product of the first series with the complex conjugate of the second series in the frequency domain. Therefore, this step is mathematically represented in the frequency domain by:

$$Im [ {G ( B \vert A )}^{virt} ] \approx k {\sum }_{j = 1}^{{N}_{s}} G ( B \vert {x}_{j} ) {G ( B \vert {x}_{j} )}^{*} \qquad ( 1 )$$

where:

k=average wavenumber at the receiver;

Nₛ=number of post-critical offset sources for receiver B;

asterisk (*)=complex conjugation (time reversal in the time domain); and

Im[G]=imaginary part of function G (Green's function).

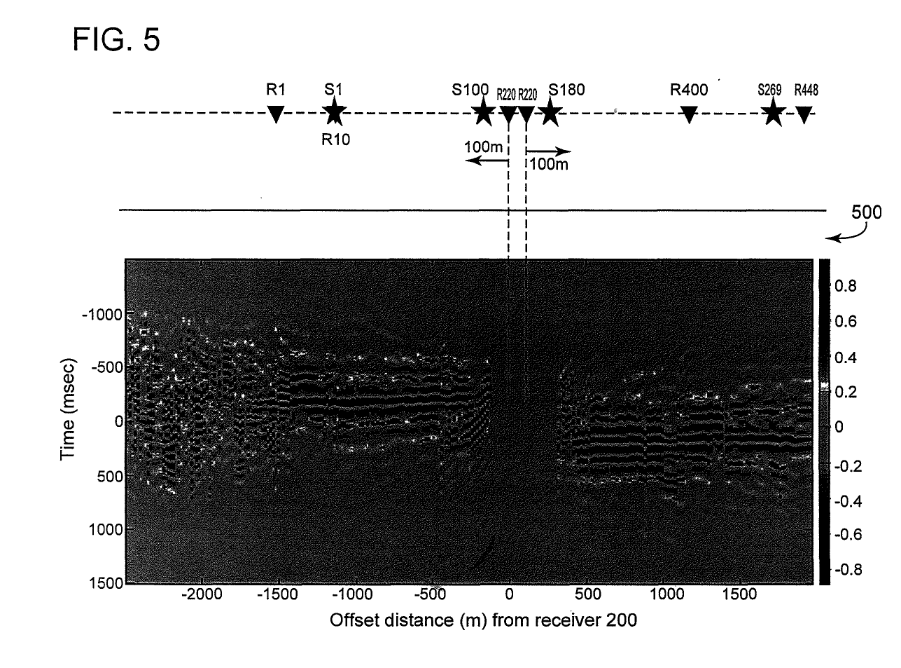

The crosscorrelation of trace records at receivers A and B from every post-critical source results in the virtual head wave that would have been emitted by a virtual source at a redatumed source position A′ on interface 106 and recorded at B with a negative excitation time corresponding to the travel time between A and A′. As every post-critical source on the same side as xⱼ generates a similar virtual refraction due to similarity of ray paths, the summation over Nₛ sources may increase the SNR of the final virtual head wave by a factor of \sqrt{Nₛ}. Signals received from multiple sources at one receiver may be referred to as a common receiver gather (CRG) where a “gather” represents a series of traces received. A CRG for two receivers A and B is a gather in which every trace is a virtual refraction trace computed by crosscorrelating the records at these two receivers originated from each post-critical offset source (discussed in detail below with reference to FIG. 5).

FIG. 1B illustrates generation of a supervirtual refraction trace calculated between receiver B and source x. First, raw receiver records are convolved with virtual traces (result of equation (1)) and then stacked over the intermediate receivers Aⱼ. The results of the convolutions are then summed over N_{g} post-critical offset intermediate receivers Aⱼ to result in a “supervirtual trace” from shot x and recorded at receiver B. Therefore, the mathematical expression for the second step is:

$${G ( B \vert x )}^{super} \approx 2 i k {\sum }_{j = 1}^{{N}_{g}} G ( {A}_{j} \vert x ) {G ( B \vert {A}_{j} )}^{virt .} \qquad ( 2 )$$

where:

i=\sqrt{−1}; and

N_{g}=number of post-critical intermediate receivers Aⱼ for receiver B.

Similar to equation (1), equation (2) increases the SNR of the supervirtual head wave by a factor of \sqrt{N_{g}}, which results in cleaner and easier to pick first arrivals or first break picks. Further, a longer source-receiver offset increases the number of intermediate receivers Aⱼ involved in the stacking step, which can result in higher SNR at these offsets. In some situations, supervirtual traces may have a high SNR, but have an oscillating appearance, and thus, not a well-defined first break. Thus, when determining a first break time to pick, several raw traces that are relatively “clean” with a relatively high SNR may be picked and the corresponding time transferred to the supervirtual data to enable the picking of first breaks on the supervirtual refraction gathers.

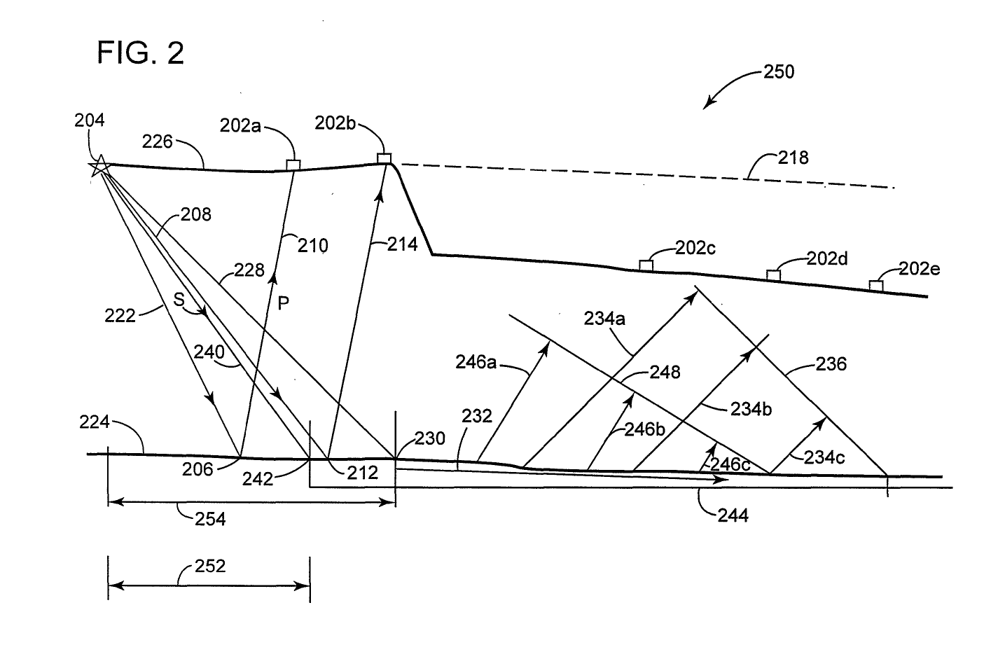

In some embodiments, SVI methodology may be applied to radial component data sets (the radial component of data recorded at receivers) to enhance picking of S-wave first breaks. For example, FIG. 2 illustrates a vertical cross-section view of propagation of an example seismic wavefield 250 in accordance with some embodiments of the present disclosure. Wavefield 250 illustrates the subsurface structure based on seismic waves generated by source 204. For example, a seismic wave radiating from source 204 propagates along trajectory 222. The seismic wave on trajectory 222 reflects from interface 224 at incident point or mid-point 206. Interface 224 may be a rock layer interface or any other subsurface interface where the density or composition of a layer of the subsurface changes. At mid-point 206, trajectory 222 reflects on ray 210 that propagates to receiver 202a. Mid-point 206 lies at a midway between source 204 and receiver 202a. Mid-point 206 provides a common depth point (CDP), also called a common mid-point (CMP) for sources and receivers symmetrically disposed about point 206 along surface 226.

The symmetrical ray paths shown by trajectory 222 and ray 210 apply to multiple wave types depending on the type of source 204 or receiver 202. For example, trajectory 222 and ray 210 may apply to a P-wave receiver or a S-wave receiver. P-wave receivers are oriented vertically and S-wave receivers are oriented horizontally. Additionally, a 3C receiver includes two horizontal receivers that are orthogonal and which record significant S-wave energy.

Source 204 generates both P-waves and S-waves. P-wave energy may be reflected back to receivers 202 as a reflected P-wave on ray 210 to receiver 202a or as a converted wave on ray 214 to receiver 202b. Receiver 202a receives the reflected P-wave on the vertical component. P-waves that propagate along trajectory 208 and impinge upon interface 224 at conversion point 212 are converted into S-waves, and generate PS-wave data that propagates along ray 214.

P-wave energy may also refract. For example, P-waves may travel on trajectory 228 and impinge upon interface 224 at point 230. A refracted wave travels along interface 224 on ray 232 and emits refracted energy to the surface on rays 234a-234c along P-wave head wave 236. P-wave head wave 236 appears on vertical component receiver data as the P-wave first break. The distance between source 204 and point 230 may be defined as the critical offset 254 for P-waves.

S-waves generated by source 204 may propagate along trajectory 240 and impinge upon interface 204 at point 242. S-waves may reflect, convert, and refract similar to P-waves. Refracted S-wave energy travels along interface 224 on ray 244 and emits refracted S-waves to the surface on rays 246a-246c. S-wave head wave 248 appears on the horizontal component receiver data. Further, the distance between source 204 and point 242 may be defined as the critical offset 252 for S-waves. In some embodiments, the refracted S-wave data may assist in the imaging of PS-wave data by being utilized in deriving a statics solution. PS-wave data is utilized to develop a model of subsurface structure.

Further, in some embodiments, the PS-waves reflect from interface 224, not at mid-point 206, but from conversion point 212 to be detected by receivers 202. Conversion point 212 is shifted away from mid-point 206 towards a particular receiver 202 in accordance with the S-wave/P-wave velocity ratio. S-wave or P-wave velocities are the speed at which the seismic P- or S-waves travel through a material. Data processing using PS-wave data may be based on a common conversion point (CCP) in place of a CMP or a CDP.

Seismic processing methods utilize receivers 202 to acquire a series of traces (or “gather”) reflected from the same common subsurface point, such as a CMP gather or a CCP gather. The traces are then summed (or “stacked”). Stacking multiple traces improves SNR over “single-fold” stack results. The “fold” indicates the number of traces in a CMP or a CCP gather. Further, additional gather types may be utilized in data processing, such as common shot gather (one source or shot received by multiple receivers), common receiver gather (multiple sources received by one receiver) (CRG), or any other suitable types based on the implementation or goals of the processing.

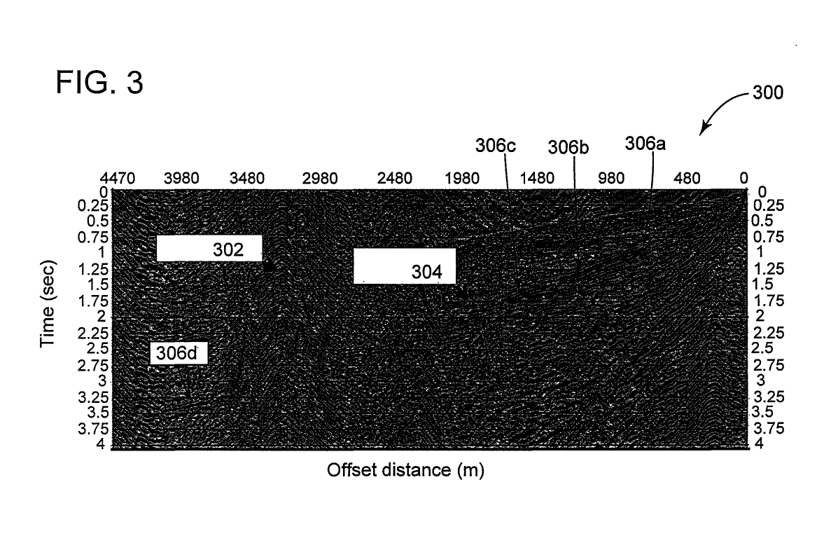

In some embodiments, seismic processing may be based on the radial component of data recorded at receivers, such as receivers 202. FIG. 3 illustrates example radial component seismic data 300 recorded by receivers 202 in accordance with some embodiments of the present disclosure. Data received by receivers 202 is processed into radial and vertical components. Data 300 represents a radial component data set. Data 300 illustrates signals obtained at receivers 202 as a function of time and offset distance. Data 300 may include sections of noise generated by pumps, generators, motors, or any other appropriate equipment proximate to receivers 202. For example, noise 302 may represent noise generated by one or more pumps or generators proximate to one or more receivers 202. Data 300 represents data collected in the time following a shot from a particular source 204. For example, data 300 may represent the received signals following a dynamite shot from a particular source numbered 161 (shot=161).

Data 300 may illustrate the arrival of PS-wave (converted wave) 304. For example, PS-wave 304 may arrive at approximately 1.75 seconds at an offset of approximately 1,980 meters. S-wave refractions 306a-306d (collectively S-wave refractions 306) may arrive after P-waves at a particular offset distance. S-wave refractions 306 may be obscured, partially or completely, in data 300 due to signal noise, pump noise, interference from reflections and other wave types, or other sources of signal interference. Because S-wave refractions 306 may not be the first arrivals, an auto-picking tool may not be able to identify them. Further, at greater offsets, the amount of interference affecting S-wave refractions 306 increases and the SNR is typically lower at farther offsets. For example, S-wave refraction 306d may be more difficult to distinguish than S-wave refraction 306a. As such, enhancement of S-wave refractions 306 may be advantageous.

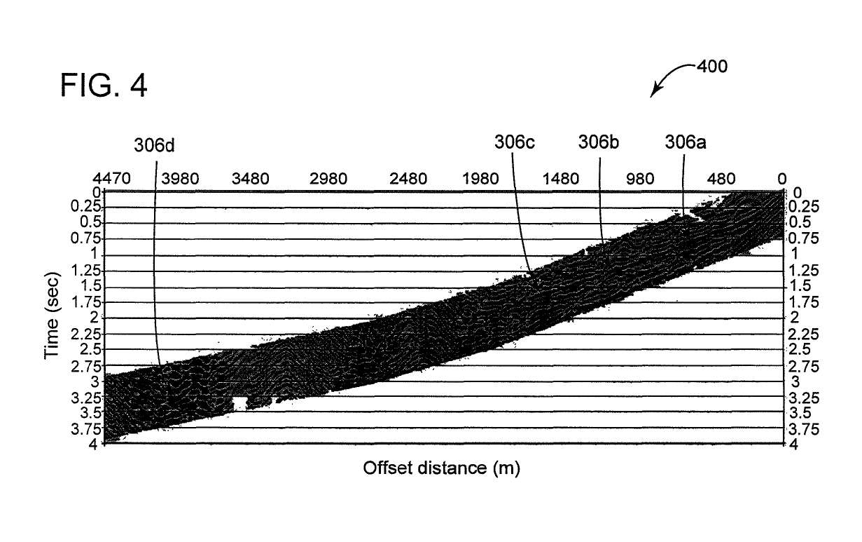

FIG. 4 illustrates an example of window output 400 of seismic data 300 shown in FIG. 3 in accordance with some embodiments of the present disclosure. A window or portion of data may be selected from seismic data 300 that may correspond to the arrivals of S-wave refractions 306 of seismic signals at receivers 202, such as a head wave arrival. For example, window output 400 illustrates signals obtained at receivers 202 as a function of time and offset distance. Window output 400 may be generated from data 300 shown in FIG. 3. The selection of the data to window may relate to how the seismic data is generated, exploration area topology, prior seismic surveys, or any other suitable criteria. Windowing and other processing, such as bandpass filtering and amplitude equalization, aim to emphasize the signal of interest, for example S-wave refractions, in the seismic data that is utilized for an SVI process. As such, further processing of the received data may be enhanced if the received data is windowed about S-wave refractions first arrivals so that S-wave refractions first arrivals are correlated with one another. Accordingly, selection of data in window output 400 is partially based on the arrival of an S-wave refraction head wave, for example, head wave 248 shown in FIG. 2. Selection of a data-window that contains the signal of interest may be performed by someone skilled in the art of seismic processing.

In some embodiments, data 300 may be filtered by, for example, applying an automatic gain control (AGC), a low-pass filter, or any other suitable filter mechanism, to generate window output 400. The filtering and gain control may be selected based on the frequency band for the S-wave refractions and characteristics of the particular implementation. For example, an AGC with a window of 1000 milliseconds may be selected. Accordingly, S-wave refractions 306a-306d may be enhanced in window output 400.

In some embodiments, received data from particular sources and receivers may be removed. For example, received data from a particular source or receiver that is inconsistent relative to other sources and receivers may be removed. Examples of inconsistencies may include polarity reversals at receivers, excessively weak sources, or other outlying sets of received data.

Moreover, sources and receivers not located at post-critical positions may be excluded from the received data. A critical offset may be established for each implementation. A critical offset is the offset distance at which the reflection time is equal to the refraction time. Thus, the critical offset is the point at which S-wave refractions begin to exist. At shorter offsets than the critical offsets, S-wave refractions do not exist. Therefore, interference from other types of waves at offsets shorter than the critical offset generates unwanted features in the data. For example, the critical offset may be approximately forty meters. However, to ensure that the influence of faster direct and reflection arrivals in shorter offsets are minimized, the shortest offset taken into account may be larger, for example one hundred meters.

FIG. 5 illustrates an example crosscorrelation 500 of a common receiver gather (CRG) with another nearby CRG in accordance with some embodiments of the present disclosure. Having applied the pre-processing steps discussed with respect to FIG. 4, a virtual refraction gather at each virtual source may be calculated according to equation (1) above. To perform the summation portion of equation (1), crosscorrelation 500 is generated for each receiver pair. For example, FIG. 5 illustrates a crosscorrelation of a CRG for receiver numbered 200 and 220 (also referred to as R200 and R220, respectively). Data is discarded from sources located between receivers numbered 200 and 220 or within the selected critical offset of either receiver numbered 200 and 220. The critical offset may be set at approximately one hundred meters. For example, data from sources numbered 100 through 180 may be discarded. The traces corresponding to sources numbered 100 through 180 are set to zero. The horizontal axis indicates the offset between the sources and receiver numbered 200. The vertical axis indicates the lag time in milliseconds in the correlation process. Both offset and time may be either positive or negative depending on the location of a particular source with respect to receiver numbered 200.

With reference to FIGS. 1A and 3, each trace in FIG. 5 relates to a virtual trace with ray path A-A′-B, computed from different sources xⱼ. Traces with positive offsets have A=R220 and B=R200 whereas traces with negative offsets have A=R200 and B=R220. For negative offsets, virtual source position A′ is associated with R200, and for positive offsets, virtual source position A′ is associated with R220. To facilitate further processing, the sign and time axis of traces with negative offsets may be inverted.

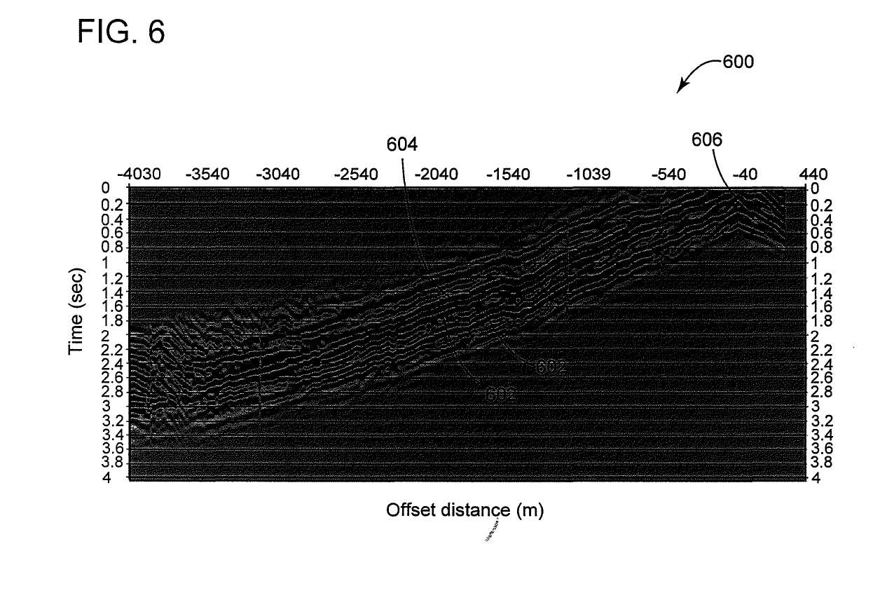

FIG. 6 illustrates an example virtual refraction gather 600 for a particular receiver numbered 45 in accordance with some embodiments of the present disclosure. Virtual refraction gather 600 is calculated according to equation (1) above such that each trace relates to a different virtual source location. Virtual refraction 602 is shown as a peak band on gather 600. Virtual refraction 602 represents the virtual refraction related to the correlation of first arriving waves from the same S-wave refraction. Additional bands 604 may run subparallel to virtual refraction 602. Bands 604 may be related to correlation of single S-wave refractions with higher-order refraction multiples. Further, a virtual refraction, similar to virtual refraction 602, may be observed in the virtual shot data set for each subterranean layer. All the virtual refractions intercept with a particular receiver at time equal approximately zero seconds (t=0 sec) with the deepest refraction (fastest) arriving earliest and the shallowest (slower) arriving later in time. For example, virtual refraction 602 may have intercept 606 at a time equal to approximately zero seconds.

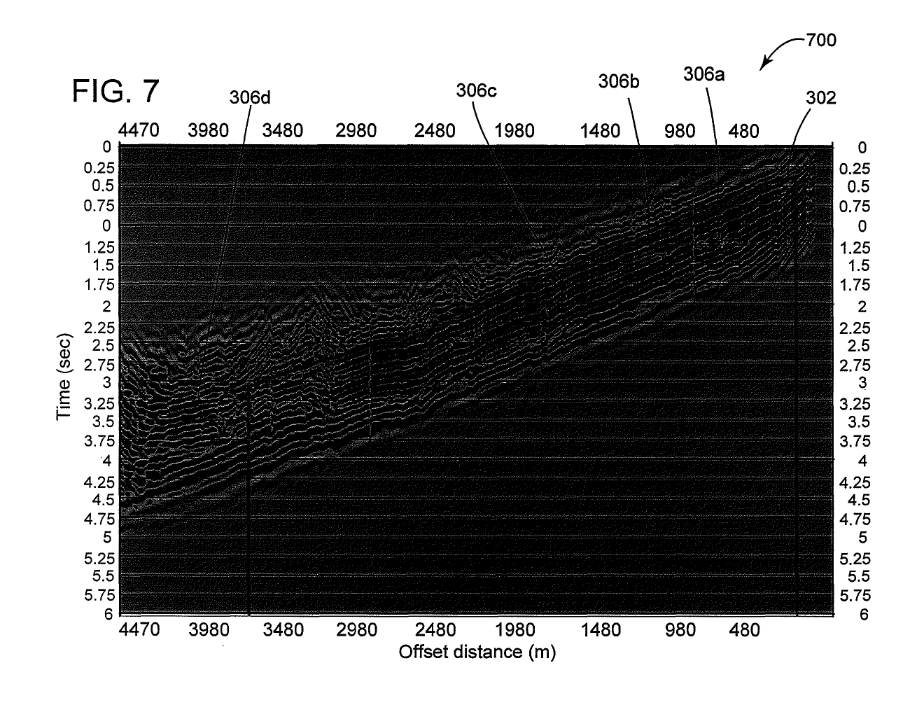

FIG. 7 illustrates an example supervirtual refraction gather 700 in accordance with some embodiments of the present disclosure. In the next processing step after virtual refraction gathers shown in FIG. 6, the supervirtual refraction gathers are calculated for each source location using equation (2). Gather 700 may include supervirtual refraction 702. As shown by comparison with FIG. 3, processing through the use of equations (1) and (2) increases the SNR such that S-wave refractions are visible. For example, S-wave refractions 306a-306d are discernible on gather 700 compared to data 300 shown in FIG. 3. Accordingly, the higher SNR supervirtual refraction gather 700 with respect to data 300 provides accurate S-wave refraction first break picks. The effects of the relative improvement may be more pronounced at further offsets. For example, comparison of S-wave refraction 306d between FIG. 3 and FIG. 7 illustrates the relative improvement. The effects of coherent noise such as strong pump noise 302 shown on FIG. 3 may be reduced.

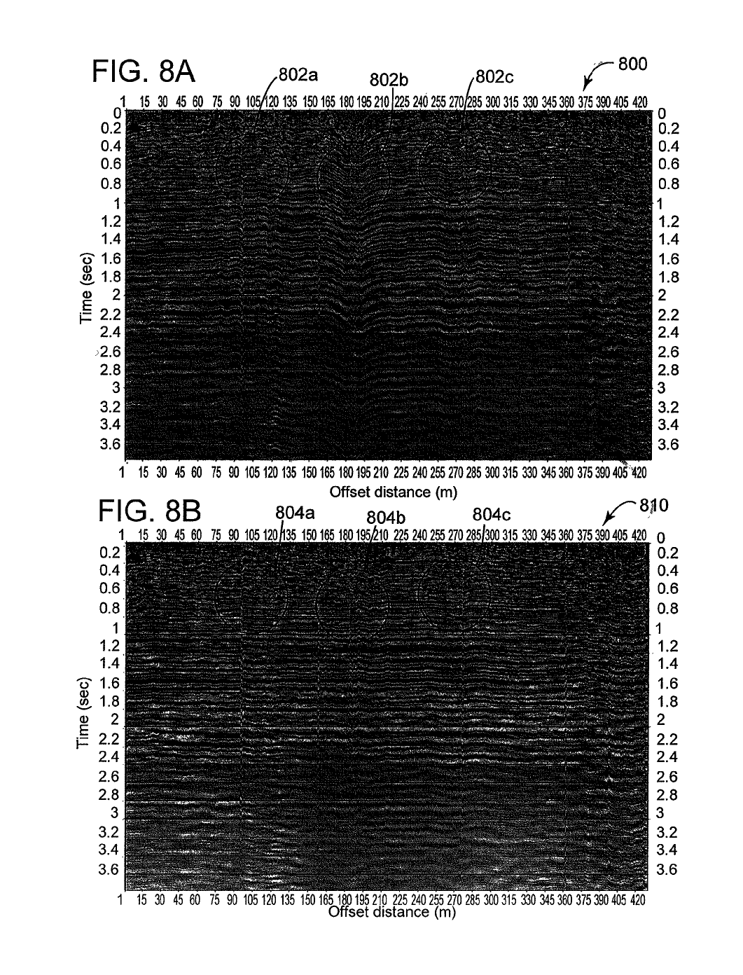

FIGS. 8A and 8B illustrate the effects of statics corrections computed from first break tomography in accordance with some embodiments of the present disclosure. FIGS. 8A and 8B are based on first breaks that were picked on supervirtual gathers, such as discussed with reference to FIG. 7. Further, FIGS. 8A and 8B illustrate images of PS reflection data and the gathers shown are common receiver stacks used to assess the quality of the statics solution obtained after running a turning ray tomography on S-wave picks obtained from supervirtual gathers, such as gather 700. Specifically, graph 800 illustrates a station stack without S-wave statics correction and graph 810 is a station stack with S-wave statics correction. As can be seen based on a comparison between zones 802a, 802b, and 802c with zones 804a, 804b, and 804c, respectively, the corrected data may allow for improved imaging of the seismic data.

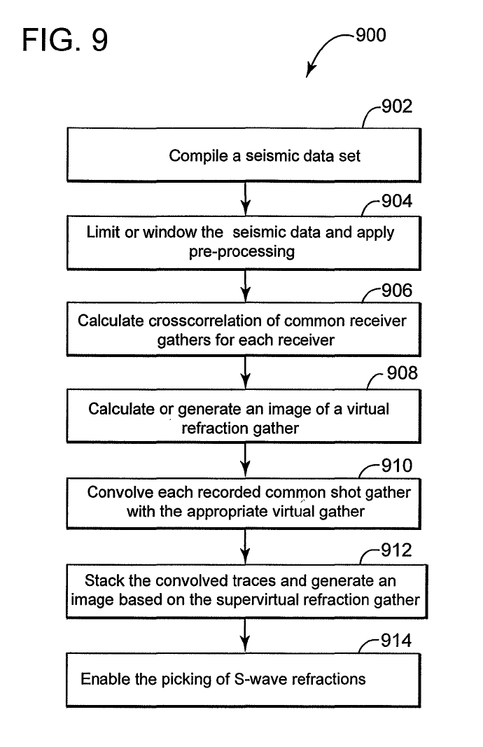

FIG. 9 illustrates a flow chart of an example method 900 of identifying S-wave refractions utilizing SVI in accordance with some embodiments of the present disclosure. The steps of method 900 are performed by a user, various computer programs, models configured to process or analyze seismic data, or any combination thereof. The programs and models include instructions stored on a computer readable medium and operable to perform, when executed, one or more of the steps described below. The computer readable media includes any system, apparatus or device configured to store and retrieve programs or instructions such as a hard disk drive, a compact disc, flash memory, or any other suitable device. The programs and models are configured to direct a processor or other suitable unit to retrieve and execute the instructions from the computer readable media. Collectively, the user or computer programs and models used to process and analyze seismic data may be referred to as a “computing system.” For illustrative purposes, method 900 is described with respect to seismic data 300 of FIG. 3; however, method 900 may be used to identify S-wave refractions utilizing SVI for any suitable seismic data set.

Method 900 may start, and at step 902, the computing system compiles, receives, or otherwise obtains, a seismic data set from data generated by a plurality of sources and recorded at a plurality of receivers during a seismic exploration or survey. For example, a seismic data set may be generated by signals received by receivers 202 shown in FIG. 2. The data is processed into radial and vertical components. The radial component data is obtained by the computing system. For example, data 300 shown in FIG. 3 may be obtained by the computing system.

At step 904, the computing system windows or otherwise limits the obtained seismic data around a S-wave refraction wavefront or head wave arrival and applies pre-processing steps. In some embodiments, pre-processing may or may not precede windowing. For example, as discussed with reference to FIG. 4, window output 400 may be generated from data 300 shown in FIG. 3 based upon the S-wave refraction wavefront or head wave arrival. For example, estimates may be made regarding time and offset at which a S-wave refraction wavefront or head wave arrival, such as head wave 248 shown in FIG. 2, reaches receivers 202. Further, the seismic data may be filtered by, for example, applying an AGC, a low-pass filter, or any other suitable filter mechanism, to generate window output 400. Data may be removed from sources and receivers that generated inconsistent readings, or sources and receivers not located outside of a critical offset, such as approximately one hundred meters.

At step 906, the computing system calculates crosscorrelation of at least two CRGs and stacks the traces belonging to the same virtual sources. For example, as shown in FIG. 5, a crosscorrelation of CRG may be calculated between R200 and R220. The crosscorrelations belonging to the same virtual ray path A-A′-B may then be summed together. For example, the crosscorrelations illustrated in FIG. 5 relate to two distinct virtual ray paths: one where the subsurface mapping of R200 acts as a virtual source and another where the subsurface mapping of R220 acts as a virtual source.

At step 908, the computing system may calculate virtual refraction gathers of the summed crosscorrelations or generate an image based on virtual refraction gathers of the summed crosscorrelations. The computing system may stack the crosscorrelations for each virtual ray path or receiver pair to form a virtual gather. For example, based on equation (1) and step 906, an image of virtual refractions may be generated as shown in FIG. 6.

At step 910, the computing system convolves each recorded common shot gather with the appropriate virtual CRG gather and stacks the convolved traces. The appropriate virtual gather has virtual source points (locations) that correspond with the receiver locations on the raw shot gather and a receiver position at the desired output receiver location. The computing system groups the supervirtual traces according to common shot points to form supervirtual gathers.

At step 912, the computing system generates an image based on the supervirtual refraction gather. For example, based on equation (2), an image of supervirtual refraction gathers may be generated as shown in FIG. 7. The application of both equation (1) and (2) to windowed data may increase the SNR for S-wave refractions and enable the S-wave refractions to be visible and identifiable.

At step 914, the computing system enables the picking of or outputs the S-wave refractions from the image for further processing. For example, the computing system may display the image to a user, provide information to an automated picking application, or otherwise enable the picking of the S-wave refractions. Further, the S-wave refraction picks may be processed by turning-ray tomography to generate a near-surface velocity model. The velocity model may be utilized to generate statics and applied to data to improve the image of subsurface formations.

Modifications, additions, or omissions may be made to method 900 without departing from the scope of the present disclosure. For example, the order of the steps may be performed in a different manner than that described and some steps may be performed at the same time. Additionally, each individual step may include additional steps without departing from the scope of the present disclosure.

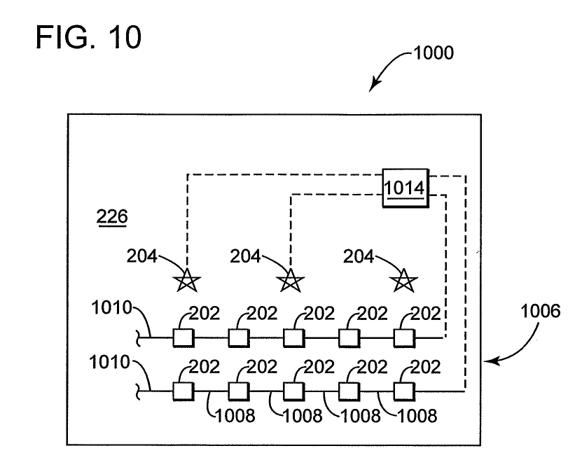

The method described with reference to FIG. 9 and the prior figures is used to enhance the processing of PS-wave data and the identification and picking of S-wave refractions, and/or enhance an S-wave velocity model produced by turning-ray tomography. FIG. 10 illustrates a schematic diagram of an example seismic exploration system 1000 in accordance with some embodiments of the present disclosure. System 1000 is configured to produce imaging of the earth's subsurface geological formations. System 1000 includes one or more seismic energy sources 204 and one or more receivers 202 located within exploration area 1006. Exploration area 1006 is any defined area selected for seismic survey or exploration. A survey of area 1006 may include activation of a seismic source that radiates an elastic wavefield that expands downwardly through the layers beneath the earth's surface. The seismic wavefield is reflected, refracted, or otherwise returned from the respective layers as a wavefront, for example a head wave recorded by receivers 202.

Receiver 202 is located on or proximate to surface 226 of the earth within exploration area 1006. Receiver 202 is any type of instrument that is utilized to transform seismic energy or vibrations into a voltage signal. Receiver 202 detects movements from energy waves below surface 226 and converts the movements into electrical energy, such as electric voltages. For example, receiver 202 may be a geophone configured to detect or record energy waves reflected from subsurface formations. Receiver 202 may comprise a vertical, horizontal, or multicomponent geophone. For example, receiver 202 may be a three component (3C) geophone, a 3C accelerometer, a 3C Digital Sensor Unit (DSU), or any suitable 3C receiver. Multiple receivers 202 are utilized within area 1006 to provide data related to multiple locations and distances from sources 204. For example, system 1000 may utilize 448 receivers (or geophones) 202. Receivers 202 may be positioned in multiple configurations, such as linear, grid, array, or any other suitable configuration. In some embodiments, receivers 202 may be positioned along one or more strings 1010. Each receiver 202 is spaced apart from adjacent receivers 202 in the same string 1010. Spacing 1008 between receivers 202 in string 1010 may be approximately the same preselected distance, or span, or spacing 1008 may vary depending on a particular application, the topology of area 1006, or any other relevant parameter. For example, spacing 1008 may be approximately ten meters. Further, multiple strings 1010 may be spaced apart by the same preselected distance. For example, spacing between strings 1010 may be approximately one meter.

As discussed with reference to FIG. 2, to generate seismic data, such as data 300 shown in FIG. 3, one or more seismic energy sources 204 are located on or proximate to surface 226 of the earth within exploration area 1006. Seismic energy source 204 may be referred to as an acoustic source, seismic source, energy source, or source 204. A particular source 204 may be spaced apart from other adjacent sources 204. Source 204 may be operated by a central controller that may coordinate the operation of several sources 204. Further, a positioning system, such as a global positioning system (GPS), may be utilized to locate or time-correlate sources 204 and receivers 202.

Source 204 is any type of seismic device that generates controlled seismic energy used to perform reflection or refraction seismic surveys, such as dynamite, an air gun, a thumper truck, a seismic vibrator, vibroseis, or any other suitable seismic energy source. For example, source 204 may be an impulsive energy source such as dynamite. With an impulsive energy source, a large amount of energy is injected into surface 226 in a very short period of time. As an example, source 204 may be an approximately two kilogram dynamite source located beneath surface 226 approximately fifteen meters.

Sources 204 and receivers 202 may be communicatively coupled to one or more computing devices 1014. One or more receivers 202 transmit raw seismic data from received seismic energy via a network to computing device 1014. A particular computing device 1014 may transmit raw seismic data to other computing devices 1014 or other site via a network. Computing device 1014 performs seismic data processing on the raw seismic data to prepare the data for interpretation. Computing device 1014 may include any instrumentality or aggregation of instrumentalities operable to compute, classify, process, transmit, receive, store, display, record, or utilize any form of information, intelligence, or data. For example, computing device 1014 may comprise a personal computer, a storage device, or any other suitable device and may vary in size, shape, performance, functionality, and price. Computing device 1014 may include random access memory (RAM), one or more processing resources such as a central processing unit (CPU) or hardware or software control logic, or other types of volatile or non-volatile memory. Additional components of computing device 1014 may include one or more disk drives, one or more network ports for communicating with external devices, various input and output (I/O) devices, such as a keyboard, a mouse, and a video display. Computing device 1014 may be located in a station truck or any other suitable enclosure. Computing device 1014 may be configured to permit communication over any type of network, such as a wireless network, a local area network (LAN), or a wide area network (WAN) such as the Internet.

In some embodiments, sources 204 are controlled to generate seismic waves in a seismic survey, and receivers 202 receive and record waves reflected by subsurface layers, oil or gas reservoirs, or other subsurface formations. The seismic survey may be repeated at various time intervals, for example, months or years apart, to examine any changes in the reservoirs. Data is collected and organized based on offset distances, which is the distance between a particular source 204 and a particular receiver 202, and the amount of time it takes for a signal from source 204 to reach a particular receiver 202, which may be referred to as “travel time.” Data collected during a seismic survey by receivers 202 may include multiple signals or seismic energy waves that are reflected in traces that may be gathered, processed, or utilized to generate a model of the subsurface formations.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. For example, seismic sources 202 in FIGS. 2 and 10 may be any combination of vibratory or impulsive seismic sources. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. For example, a receiver does not have to be turned on but must be configured to receive reflected energy.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability. For example, the computing system described in method 900 with respect to FIG. 9 may be stored in tangible computer readable storage media.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims. Moreover, while the present disclosure has been described with respect to various embodiments, it is fully expected that the teachings of the present disclosure may be combined in a single embodiment as appropriate. Instead, the scope of the invention is defined by the appended claims.

What is claimed is:

1. A method for analysis of seismic data comprising:
receiving a seismic data set from data generated by a plurality of receivers;
calculating crosscorrelations of pairs of common receiver gathers from the seismic data set for each of the plurality of receivers;
summing the crosscorrelations associated with each of a plurality of virtual ray paths, the plurality of virtual ray paths based on each of the plurality of receivers functioning as a virtual source;
calculating a plurality of virtual refraction gathers of the summed crosscorrelations;
convolving each of the plurality of virtual refraction gathers with the seismic data set;
summing the plurality of convolutions associated with each of the plurality of virtual ray paths;
calculating a supervirtual refraction gather of the plurality of summed convolutions; and
outputting an S-wave refraction from the supervirtual refraction gather.

2. The method of claim 1, wherein the seismic data set is radial component data generated by a plurality of seismic sources.

3. The method of claim 1, further comprising generating an image of subsurface formations.

4. The method of claim 1, further comprising generating a near-surface velocity model.

5. The method of claim 1, further comprising windowing the seismic data set around a head wave containing the S-wave refraction.

6. The method of claim 1, further comprising pre-processing the seismic data set to remove noise.

7. The method of claim 6, wherein pre-processing includes filtering the seismic data set.

8. The method of claim 6, wherein pre-processing includes:
identifying a particular receiver that provided outlying seismic data; and
eliminating the outlying seismic data from the seismic data set.

9. The method of claim 1, further comprising:
picking the S-wave refraction from the supervirtual refraction gather; and
utilizing the picked S-wave refraction in turning-ray tomography.

10. A seismic processing system, comprising:
a plurality of receivers configured to receive seismic data;
a computing system configured to:
receive a seismic data set from data generated by the plurality of receivers;
calculate crosscorrelations of pairs of common receiver gathers from the seismic data set for each of the plurality of receivers;
sum the crosscorrelations associated with each of a plurality of virtual ray paths, the plurality of virtual ray paths based on each of the plurality of receivers functioning as a virtual source;
calculate a plurality of virtual refraction gathers of the summed crosscorrelations;
convolve each of the plurality of virtual refraction gathers with the seismic data set;
sum the plurality of convolutions associated with each of the plurality of virtual ray paths;
calculate a supervirtual refraction gather of the plurality of summed convolutions; and
output an S-wave refraction from the supervirtual refraction gather.

11. The system of claim 10, wherein the seismic data set is radial component data generated by a plurality of seismic sources.

12. The system of claim 10, wherein the computing system is further configured to generate an image of subsurface formations.

13. The system of claim 10, wherein the computing system is further configured to generate a near-surface velocity model.

14. The system of claim 10, wherein the computing system is further configured to window the seismic data set around a head wave containing the S-wave refraction.

15. The system of claim 10, wherein the computing system is further configured to pre-process the seismic data set to remove noise.

16. The system of claim 15, wherein pre-processing includes filtering the seismic data set.

17. A non-transitory computer-readable medium, comprising:
computer-executable instructions carried on the computer-readable medium, the instructions, when executed, causing a processor to:
receive a seismic data set from data generated by a plurality of receivers;
calculate crosscorrelations of pairs of common receiver gathers from the seismic data set for each of the plurality of receivers;
sum the crosscorrelations associated with each of a plurality of virtual ray paths, the plurality of virtual ray paths based on each of the plurality of receivers functioning as a virtual source;
calculate a plurality of virtual refraction gathers of the summed crosscorrelations;
convolve each of the plurality of virtual refraction gathers with the seismic data set;
sum the plurality of convolutions associated with each of the plurality of virtual ray paths;
calculate a supervirtual refraction gather of the plurality of summed convolutions; and
output an S-wave refraction from the supervirtual refraction gather.

18. The non-transitory computer-readable medium of claim 17, wherein the seismic data set is radial component data generated by a plurality of seismic sources.

19. The non-transitory computer-readable medium of claim 17, wherein the processor is further caused to generate an image of subsurface formations.

20. The non-transitory computer-readable medium of claim 17, wherein the processor is further caused to generate a near-surface velocity model.
